(19) United States
(12) Patent Application Publication
(10) Pub. No.: US 2022/0391803 A1
(43) Pub. Date: Dec. 8, 2022

(54) METHOD AND SYSTEM FOR USING ARTIFICIAL INTELLIGENCE FOR TASK MANAGEMENT

(71) Applicant: JPMorgan Chase Bank, N.A., New York, NY (US)

(72) Inventors: Salwa Husam ALAMIR, Bournemouth (GB); Sameena SHAH, Scarsdale, NY (US); Andrea STEFANUCCI, Hoboken, NJ (US); Maria Manuela VELOSO, New York, NY (US)

(73) Assignee: JPMorgan Chase Bank, N.A., New York, NY (US)

(21) Appl. No.: 17/341,782

(22) Filed: Jun. 8, 2021

(51) Int. Cl. G06Q 10/06; G06N 20/00

(52) U.S. Cl. CPC G06Q 10/06313; G06Q 10/063114; G06Q 10/063112; G06Q 10/06316; G06N 20/00

(57) ABSTRACT

A method and a system for managing a task are provided. The method includes: receiving, from a user, a description of a first task that relates to a first project that has not been completed; generating, by using a machine learning algorithm, a plan for executing the first task based on the received description of the first task and historical task management information that relates to at least one task that has been completed; initiating an execution of the first task based on the generated plan; and tracking the execution of the first task in order to determine whether the execution is progressing in accordance with the generated plan. The historical task management information includes task-specific skill requirements and task duration.

### BACKGROUND

### 1. Field of the Disclosure

This technology generally relates to methods and systems for task management, and more particularly to using artificial intelligence techniques to increase efficiency in task management and to improve understanding and compliance with task requirements.

### 2. Background Information

In a large organization such as a multinational corporation, project management and personnel utilization are important for sustained success and profitability. Inefficiencies in these aspects may cause competitive disadvantages and a lack of growth.

In an organization that has a large number of employees, i.e., on the order of hundreds of thousands, project planning that is performed manually by individual users may lead to sub-optimal plans that have time periods during which some employees are not assigned tasks and are generally underutilized. This may also result in a slow, disjointed process that lacks transparency and thus causes misunderstandings and/or noncompliance among employees.

Accordingly, there is a need for a methodology for optimizing task management and project planning that maximizes employee efficiency and employee understanding and compliance with task requirements.

### SUMMARY

The present disclosure, through one or more of its various aspects, embodiments, and/or specific features or sub-components, provides, inter alia, various systems, servers, devices, methods, media, programs, and platforms for using artificial intelligence techniques to increase efficiency in task management and to improve understanding and compliance with task requirements.

According to an aspect of the present disclosure, a method for managing a task is provided. The method is implemented by at least one processor. The method includes: receiving, by the at least one processor from a user, a description of a first task that relates to a first project that has not been completed; generating, by the at least one processor, a plan for executing the first task based on the received description of the first task and historical task management information that relates to at least one task that has been completed; initiating, by the at least one processor, an execution of the first task based on the generated plan; and tracking, by the at least one processor, the execution of the first task in order to determine whether the execution is progressing in accordance with the generated plan.

The historical task management information may include, for each of the at least one task that has been completed, information that relates to at least one respective skill required for completing the respective task and information that relates to a respective amount of time required for completing the respective task. The generating of the plan may include using a machine learning algorithm that is trained by using the historical task management information and that generates an output that includes first information that relates to identifying at least one skill required for performing the first task and second information that relates to an amount of time expected to be required for completing the execution of the first task.

The historical task management information may further include personal information that identifies a plurality of persons and indicates, for each person included in the plurality of persons, a respective list of skills. The output generated by the machine learning algorithm may further include third information that relates to identifying at least one person from among the plurality of persons to be assigned to perform the first task.

The historical task management information may further include, for each of the at least one task that has been completed, information that relates to a priority level for the respective task. The output generated by the machine learning algorithm may further include fourth information that relates to assigning a priority level to the first task.

The historical task management information may further include, for each of the at least one task that has been completed, information that relates to a complexity of the respective task. The output generated by the machine learning algorithm may further include fifth information that relates to determining a complexity of the first task.

The method may further include analyzing, by the at least one processor, the received description of the first task to determine whether the first task is duplicative of a second task that is currently being executed. When the first task is determined as being duplicative, the method may further include transmitting, to the user, a message that includes a notification of the duplicativeness determination and a recommendation for adjusting the description of the first task in order to avoid a subsequent redundancy.

The method may further include analyzing, by the at least one processor, a result of the tracking of the execution of the first task to detect a problem caused by the execution of the first task; and transmitting, to the user, a message that includes a notification of the detected problem and a recommendation for adjusting the description of the first task in order to overcome the detected problem.

The method may further include determining, based on a result of the tracking, whether the execution of the first task is expected to cause a delay in a completion of the first project; and transmitting, to the user, a status message that includes information that relates to a result of the determining of whether the execution of the first task is expected to cause the delay in the completion of the first project.

When a determination is made that the execution of the first task is expected to cause the delay in the completion of the first project, the method may further include identifying at least one additional resource to be applied to the first project in order to overcome the expected delay.

According to another exemplary embodiment, a computing apparatus for managing a task is provided. The computing apparatus includes: a processor; a memory; and a communication interface coupled to each of the processor and the memory. The processor is configured to: receive, from a user via the communication apparatus, a description of a first task that relates to a first project that has not been completed; generate a plan for executing the first task based on the received description of the first task and historical task management information that relates to at least one task that has been completed; initiate an execution of the first task based on the generated plan; and track the execution of the first task in order to determine whether the execution is progressing in accordance with the generated plan.

The historical task management information may include, for each of the at least one task that has been completed, information that relates to at least one respective skill required for completing the respective task and information that relates to a respective amount of time required for completing the respective task. The processor may be further configured to generate the plan by using a machine learning algorithm that is trained by using the historical task management information and that generates an output that includes first information that relates to identifying at least one skill required for performing the first task and second information that relates to an amount of time expected to be required for completing the execution of the first task.

The historical task management information may further include personal information that identifies a plurality of persons and indicates, for each person included in the plurality of persons, a respective list of skills. The output generated by the machine learning algorithm may further include third information that relates to identifying at least one person from among the plurality of persons to be assigned to perform the first task.

The historical task management information may further include, for each of the at least one task that has been completed, information that relates to a priority level for the respective task. The output generated by the machine learning algorithm may further include fourth information that relates to assigning a priority level to the first task.

The historical task management information may further include, for each of the at least one task that has been completed, information that relates to a complexity of the respective task. The output generated by the machine learning algorithm may further include fifth information that relates to determining a complexity of the first task.

The processor may be further configured to: analyze the received description of the first task to determine whether the first task is duplicative of a second task that is currently being executed; and transmit, to the user via the communication interface when the first task is determined as being duplicative, a message that includes a notification of the duplicativeness determination and a recommendation for adjusting the description of the first task in order to avoid a subsequent redundancy.

The processor may be further configured to: analyze a result of the tracking of the execution of the first task to detect a problem caused by the execution of the first task; and transmit, to the user via the communication interface, a message that includes a notification of the detected problem and a recommendation for adjusting the description of the first task in order to overcome the detected problem.

The processor may be further configured to: determine, based on a result of the tracking, whether the execution of the first task is expected to cause a delay in a completion of the first project, and transmit, to the user via the communication interface, a status message that includes information that relates to a result of the determination of whether the execution of the first task is expected to cause the delay in the completion of the first project.

When a determination is made that the execution of the first task is expected to cause the delay in the completion of the first project, the processor may be further configured to identify at least one additional resource to be applied to the first project in order to overcome the expected delay.

According to yet another exemplary embodiment, a non-transitory computer readable storage medium storing instructions for managing a task is provided. The storage medium includes executable code which, when executed by a processor, causes the processor to: receive, rom a user, a description of a first task that relates to a first project that has not been completed; generate a plan for executing the first task based on the received description of the first task and historical task management information that relates to at least one task that has been completed; initiate an execution of the first task based on the generated plan; and track the execution of the first task in order to determine whether the execution is progressing in accordance with the generated plan.

The historical task management information may include, for each of the at least one task that has been completed, information that relates to at least one respective skill required for completing the respective task and information that relates to a respective amount of time required for completing the respective task. The executable code may be further configured to cause the processor to generate the plan by using a machine learning algorithm that is trained by using the historical task management information and that generates an output that includes first information that relates to identifying at least one skill required for performing the first task and second information that relates to an amount of time expected to be required for completing the execution of the first task.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for using artificial intelligence techniques to increase efficiency in task management and to improve understanding and compliance with task requirements.

FIG. 4 is a flowchart of an exemplary process for implementing a method for using artificial intelligence techniques to increase efficiency in task management and to improve understanding and compliance with task requirements.

FIG. 5 is a flow diagram of a process for using artificial intelligence techniques to increase efficiency in task management and to improve understanding and compliance with task requirements, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

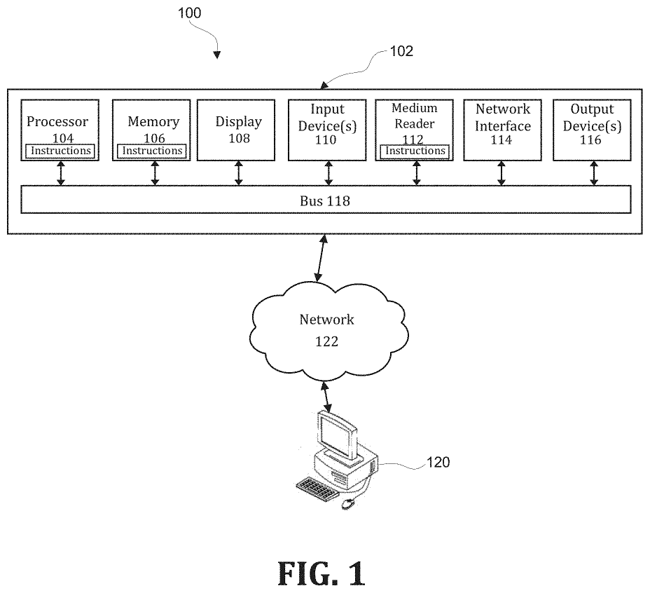

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for using artificial intelligence techniques to increase efficiency in task management and to improve understanding and compliance with task requirements.

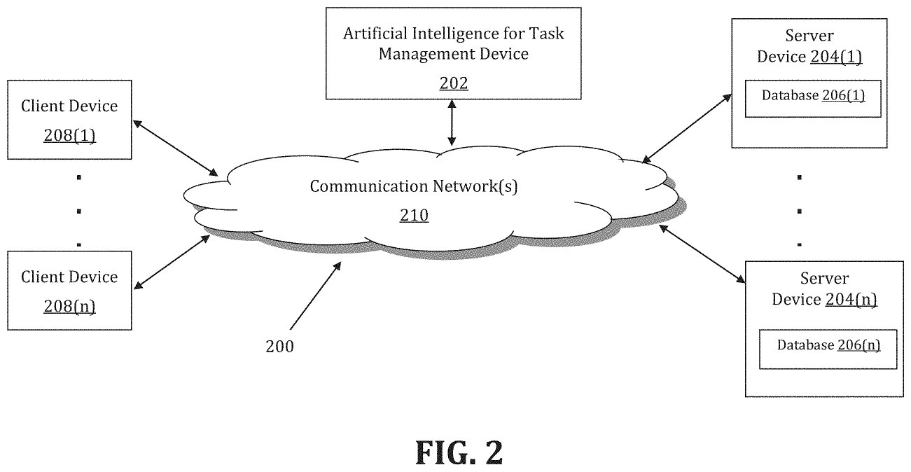

Referring to FIG. 2, a schematic of an exemplary network environment 200 for implementing a method for using artificial intelligence techniques to increase efficiency in task management and to improve understanding and compliance with task requirements is illustrated. In an exemplary embodiment, the method is executable on any networked computer platform, such as, for example, a personal computer (PC).

The method for using artificial intelligence techniques to increase efficiency in task management and to improve understanding and compliance with task requirements may be implemented by an Artificial Intelligence for Task Management (AITM) device 202. The AITM device 202 may be the same or similar to the computer system 102 as described with respect to FIG. 1. The AITM device 202 may store one or more applications that can include executable instructions that, when executed by the AITM device 202, cause the AITM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the AITM device 202 itself, may be located in virtual server(s) running in a cloud-based computing environment rather than being tied to one or more specific physical network computing devices. Also, the application(s) may be running in one or more virtual machines (VMs) executing on the AITM device 202. Additionally, in one or more embodiments of this technology, virtual machine(s) running on the AITM device 202 may be managed or supervised by a hypervisor.

In the network environment 200 of FIG. 2, the AITM device 202 is coupled to a plurality of server devices 204(1)-204(n) that hosts a plurality of databases 206(1)-206(n), and also to a plurality of client devices 208(1)-208(n) via communication network(s) 210. A communication interface of the AITM device 202, such as the network interface 114 of the computer system 102 of FIG. 1, operatively couples and communicates between the AITM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AITM device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and AITM devices that efficiently implement a method for using artificial intelligence techniques to increase efficiency in task management and to improve understanding and compliance with task requirements.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The AITM device 202 may be a standalone device or integrated with one or more other devices or apparatuses, such as one or more of the server devices 204(1)-204(n), for example. In one particular example, the AITM device 202 may include or be hosted by one of the server devices 204(1)-204(n), and other arrangements are also possible. Moreover, one or more of the devices of the AITM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the AITM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to task management history and personnel utilization.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the AITM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the AITM device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the AITM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the AITM device 202, the server devices 204(1)-204(n), or the client devices 208(1)-208(n), for example, may be configured to operate as virtual instances on the same physical machine. In other words, one or more of the AITM device 202, the server devices 204(1)-204(n), or the client devices 208(1)-208(n) may operate on the same physical device rather than as separate devices communicating through communication network(s) 210. Additionally, there may be more or fewer AITM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

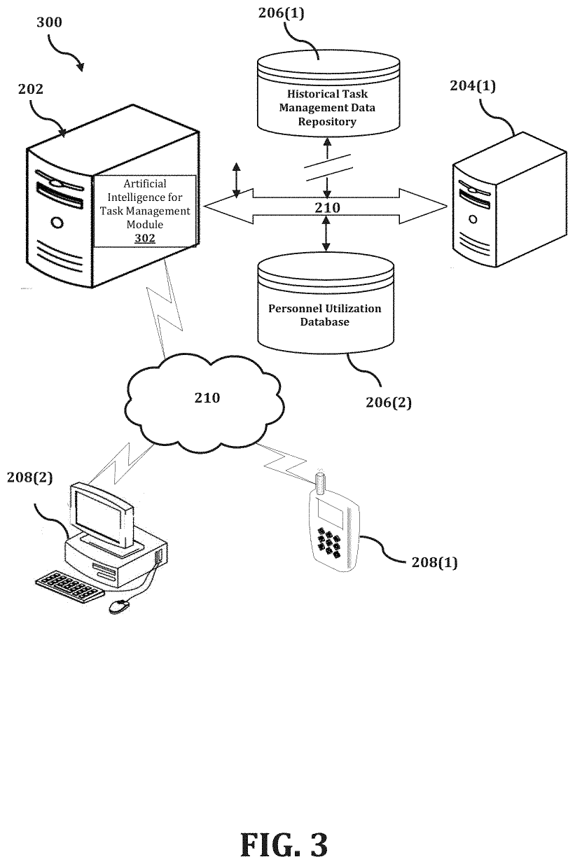

The AITM device 202 is described and illustrated in FIG. 3 as including an artificial intelligence for task management module 302, although it may include other rules, policies, modules, databases, or applications, for example. As will be described below, the artificial intelligence for task management module 302 is configured to implement a method for using artificial intelligence techniques to increase efficiency in task management and to improve understanding and compliance with task requirements.

An exemplary process 300 for implementing a mechanism for using artificial intelligence techniques to increase efficiency in task management and to improve understanding and compliance with task requirements by utilizing the network environment of FIG. 2 is illustrated as being executed in FIG. 3. Specifically, a first client device 208(1) and a second client device 208(2) are illustrated as being in communication with AITM device 202. In this regard, the first client device 208(1) and the second client device 208(2) may be “clients” of the AITM device 202 and are described herein as such. Nevertheless, it is to be known and understood that the first client device 208(1) and/or the second client device 208(2) need not necessarily be “clients” of the AITM device 202, or any entity described in association therewith herein. Any additional or alternative relationship may exist between either or both of the first client device 208(1) and the second client device 208(2) and the AITM device 202, or no relationship may exist.

Further, AITM device 202 is illustrated as being able to access a historical task management data repository 206(1) and a personnel utilization database 206(2). The artificial intelligence for task management module 302 may be configured to access these databases for implementing a method for using artificial intelligence techniques to increase efficiency in task management and to improve understanding and compliance with task requirements.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the AITM device 202 via broadband or cellular communication. Of course, these embodiments are merely exemplary and are not limiting or exhaustive.

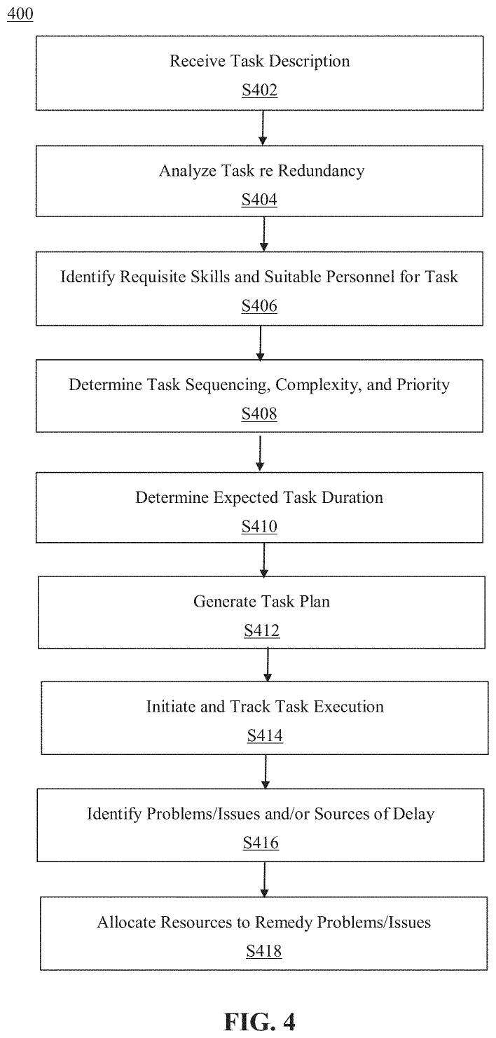

Upon being started, the artificial intelligence for task management module 302 executes a using artificial intelligence techniques to increase efficiency in task management and to improve understanding and compliance with task requirements. An exemplary process for using artificial intelligence techniques to increase efficiency in task management and to improve understanding and compliance with task requirements is generally indicated at flowchart 400 in FIG. 4.

In process 400 of FIG. 4, at step S402, the artificial intelligence for task management module 302 receives a description of a task that relates to a project that is upcoming or ongoing. In an exemplary embodiment, the task description includes a description of the requirement(s) for completing the task, an estimate of complexity, an estimated amount of time that is expected to be required for completing the task, an assignee, and a priority (i.e., high, medium, or low).

At step S404, the artificial intelligence for task management module 302 analyzes the received task description to determine whether there is any redundancy, i.e., whether the newly received task is duplicative of an existing task. In an exemplary embodiment, the task description may also be checked for quality, i.e., whether any similar tasks have caused downstream issues that may be replicated by the newly received task. In an exemplary embodiment, a result of the analysis of the task description may be provided in a notification message that is transmitted to a user from whom the task description was received.

At step S406, the artificial intelligence for task management module 302 identifies requisite skills and suitable personnel for performing the task. In an exemplary embodiment, the artificial intelligence for task management module 302 uses a machine learning algorithm that is trained by using historical task management information that is stored in the historical task management data repository 206(1) and that outputs information that identifies the requisite skills for performing the current task. The historical task management information may also include information that identifies a personnel roster together with a corresponding list of skills for each person included on the roster, and the machine learning algorithm may also retrieve information relating to personnel availability from personnel utilization database 206(2). Based on this information, a suitable person or persons for performing the task may be indicated.

At step S408, the artificial intelligence for task management module 302 determines a task sequencing, a task complexity, and a task priority for the current task. In an exemplary embodiment, the machine learning algorithm that has been trained on the historical task management data uses the task description as an input and generates an output that includes each of 1) information that relates to task sequencing with respect to the current task, 2) information that relates to a complexity of the current task, and 3) information that relates to a priority of the current task.

At step S410, the artificial intelligence for task management module 302 determines an expected task duration for the current task. In an exemplary embodiment, the machine learning algorithm uses the task description and the historical task management information to generate an output that indicates an expected task duration based on the determinations regarding required skills, task sequencing, complexity, and priority.

At step S412, the artificial intelligence for task management module 302 generates a task plan for the current task. In an exemplary embodiment, the task plan includes an identification of one or more persons to whom the task is to be assigned and a projected schedule for executing and completing the task.

At step S414, the artificial intelligence for task management module 302 initiates an execution of the task and then tracks the progress of the task during execution with reference to the task plan generated in step S412. Then, at step S416, the artificial intelligence for task management module 302 identifies problems and issues, also referred to herein as “bugs”, and/or sources of delay in the execution and completion of the task. In this aspect, when the execution of the task is progressing in accordance with the plan, there may be no problems or issues and therefore no delays, and the task execution may proceed to completion.

However, when a problem or issue is identified, and in particular when the identified problem or issue is deemed as potentially causing a delay in the completion of the project, then at step S418, the artificial intelligence for task management module 302 allocates resources to remedy the identified problem and/or issue. In an exemplary embodiment, the allocation of resources may entail determining which additional personnel have the proper skill set and availability to address the identified problem and then assigning the task to the additional personnel.

In an exemplary embodiment, a framework for completely transforming the handling of task management is provided. Tasks that are created are subjected to a task analysis process that can inform a user whether a particular task, as described by the user, is likely to cause downstream issues. The user can then revise the task description in such a way that increases the likelihood of assignees understanding the requirement and therefore completing the task without sending back for clarification.

Tasks then can move towards a planning module where they are automatically planned for sprints. The planning module learns features, such as duration, user skills, and task precedence from historical tasks in order to generate an optimal plan.

As tasks are being executed, a feedback loop is introduced via a module that monitors how closely the assignees are following the plans. For example, if a task duration is estimated to take two days and the assignee completes the task in three days, this data is fed back to the model in order to continuously improve model accuracy.

Task tracking is a key module with respect to following task progress throughout the rest of the lifecycle of the task. For example, a software development task can be tracked throughout the software development lifecycle. This means that as the code is written for a task, the metadata related to the code such as unit test coverage, code quality, and other attributes can be linked to the task. If a bug appears as a result of executing this code, the bug can be associated with the original task. The task tracking module then feeds the task analysis module so that tasks that may cause these downstream issues in the future may be rejected by the task analysis module.

Task generation is then a module that is able to generate tasks automatically as a result of the task tracking module. As an extension of the example above, if a piece of code results in a bug, a new task can be generated automatically in order to fix the bug, rather than waiting for an end user to detect the bug and manually raise it as an issue.

As end users are able to create tasks when bugs are found, when multiple users encounter the same issue, then multiple tasks may be created with the purpose of fixing a single bug. Thus, another goal of the task analysis module is to warn users when creating tasks as to whether a similar type of task exists or has already been created. In an exemplary embodiment, the task analysis module questions whether or not a particular task should be completed at all.

Finally, by tracking tasks, transparency is provided with respect to the end-to-end process in order to show whether or not a project is on-track to meet goals and timelines. In addition to the benefits of the transparency alone, by combining this with the skills estimators, the skill sets that are needed in order to complete the tasks for the projects that are falling behind can be identified. These skills can drive the hiring process, and/or internal resources that have these skills available from projects that are ahead of schedule can be assigned to help. This, in turn, makes internal resources more fungible.

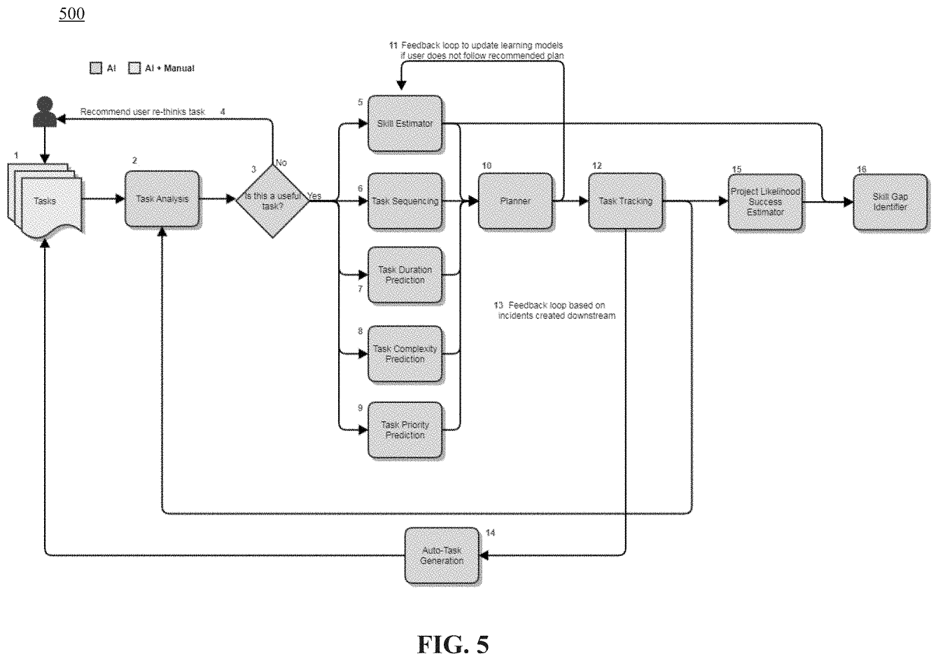

FIG. 5 is a flow diagram 500 of a process for using artificial intelligence techniques to increase efficiency in task management and to improve understanding and compliance with task requirements, according to an exemplary embodiment.

Flow diagram 500 illustrates a process flow as follows:

1) Tasks: In an exemplary embodiment, each task has a description of the requirement(s), an estimate of complexity, an estimate of duration for completion, an assignee, and a priority, i.e., high priority, medium priority, or low priority.

2) Task Analysis module: This module performs analysis in order to determine whether a task should actually be completed, and also performs a quality check on each task. For example, if multiple users create a task to fix one particular bug, there could be multiple tasks that refer to the same issue. In an exemplary embodiment, at the time of task creation, the task analysis module determines whether a similar task already exists. The task analysis module also receives feedback from the task tracking module in order to warn users that tasks that are similar to the one they have created have caused issues downstream, with a recommendation on how to improve the task. For example, the task analysis module may provide a recommendation to add more information to the task description.

3) is this a useful task?: Based on the output of the task analysis module, a decision is made at this stage regarding whether to recommend that user revise/change the task, or whether the task can continue to the rest of the pipeline.

4) Recommend user re-thinks task: Task returned to user with recommendation.

5) Skill Estimator module: Based on previous tasks that have been completed by each assignee, the skills are learned for each person such that future tasks can be assigned to people who have skills that are suitable for completing each task.

6) Task Sequencing module: Based on previous tasks that have been completed, an optimal sequence of tasks is learned. For example, for an optimal task sequence, the Task Sequencing module may learn that high priority tasks are to be completed first and that a user interface is to be completed before completing a backend. The optimal task sequences will then be used in the Planner module.

7) Task Duration Prediction module: Based on previous tasks that have been completed, an optimal duration of tasks is learned using features such as priority, and even assignee, as some individuals may complete a certain type of task faster than others. As a result, the Task Duration Prediction module predicts a respective duration of each subsequent task. The optimal task durations will be a factor in the Planner module.

8) Task Complexity Prediction: Based on previous tasks that have been completed, a complexity of each task is learned. As a result, the Task Complexity Prediction module predicts a respective complexity of each subsequent task.

9) Task Priority Prediction module: Based on previous tasks that have been completed, an optimal priority of tasks is learned. As a result, the Task Priority Prediction module predicts a priority of each subsequent task.

10) Planner module: The Planner module receives all of the learned variables from the Skill Estimator module, the Task Sequencing module, the Task Duration Prediction module, the Task Complexity Prediction module, and the Task Priority Prediction module, and uses these outputs to generate an optimal plan for completing each respective task. Further, the Planner module also assigns tasks to persons that have suitable skills for completing each task. In an exemplary embodiment, the Planner module uses a mixed integer programming approach to accomplish these objectives.

11) Feedback loop to update models: Each plan that is provided to users is only a recommendation. Thus, whether users follow this plan is monitored, and feedback that indicates any deviations from the plan is provided back to the models in order to facilitate continuous learning.

12) Task Tracking module: The Task Tracking module tracks each task through its lifecycle. For example, for a software engineering task, software will be developed, then tested, then scanned for code quality, until the software is ultimately deployed into a production environment. Once in the production environment, a bug may appear. By completing this traceability exercise, the test and scan results may be obtained, and these results may then be combined with the original task description in order to facilitate issue identification and determinations re potential remedies.

13) Feedback loop to the Task Analysis module: Based on the output of the Task Tracking module, feedback is provided such that the Task Analysis module is able to inform users when a similar type of task has previously caused issues downstream.

14) Auto-Task Generation module: When an issue is detected downstream by the Task Tracking module, a new task can automatically be created in order to fix the corresponding bug rather than wait for a human to find the issue and manually generate a new task for addressing the bug.

15) Project Likelihood Success Estimator module: Based on all of the data provided by the Task Tracking module, the Project Likelihood Success Estimator predicts a likelihood of a particular task being late and a likelihood of a particular task resulting in a bug. Each prediction is presented as a real-time probability and is updated as new events are received from the Task Tracking module. Delays in tasks are aggregated to the project level such that a prediction can be made regarding whether or not a delay in completing a particular task may cause a corresponding delay in a corresponding project as a whole.

16) Skill Gap Identifier module: When the Project Likelihood Success Estimator module predicts that there is a high probability that a project will be delayed, then extra resources can be added to the project in order to overcome the expected delay and restore an ability to complete the project in accordance with its original schedule. However, there may remain a question regarding which resources are needed. By identifying the skills needed to complete the remaining tasks based on input received from the Skill Estimator module, the Skill Gap Identifier module determines which resources may be most useful for addressing a particular situation, and then developers with those skills can be assigned from other projects in order to help. As a result, the overall fungibility of resources is increased.

Accordingly, with this technology, an optimized process for using artificial intelligence techniques to increase efficiency in task management and to improve understanding and compliance with task requirements is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for managing a task, the method being implemented by at least one processor, the method comprising:
receiving, by the at least one processor from a user, and storing in a memory, a description of a first task and a description of a second task that relate to a first project that has not been completed;
performing analysis of the first task and the second task using a machine learning algorithm;
determining whether the first task and the second task have utility for the first project or not;
preventing further processing of the second task, when the machine learning algorithm determines that the second task does not have utility for the first project; and
when the first task is determined to have utility, performing:
generating, by the at least one processor, a plan for executing the first task based on the received description of the first task and historical task management information that relates to at least one task that has been completed;
initiating, by the at least one processor, an execution of the first task based on the generated plan; and
tracking, by the at least one processor, the execution of the first task in order to determine whether the execution is progressing in accordance with the generated plan.

2. The method of claim 1, wherein the historical task management information includes, for each of the at least one task that has been completed, information that relates to at least one respective skill required for completing the respective task and information that relates to a respective amount of time required for completing the respective task, and
wherein the generating of the plan comprises using the machine learning algorithm that is trained by using the historical task management information and that generates an output that includes first information that relates to identifying at least one skill required for performing the first task and second information that relates to an amount of time expected to be required for completing the execution of the first task.

3. The method of claim 2, wherein the historical task management information further includes personal information that identifies a plurality of persons and indicates, for each person included in the plurality of persons, a respective list of skills, and
wherein the output generated by the machine learning algorithm further includes third information that relates to identifying at least one person from among the plurality of persons to be assigned to perform the first task.

4. The method of claim 3, wherein the historical task management information further includes, for each of the at least one task that has been completed, information that relates to a priority level for the respective task, and
wherein the output generated by the machine learning algorithm further includes fourth information that relates to assigning a priority level to the first task.

5. The method of claim 4, wherein the historical task management information further includes, for each of the at least one task that has been completed, information that relates to a complexity of the respective task, and
wherein the output generated by the machine learning algorithm further includes fifth information that relates to determining a complexity of the first task.

6. The method of claim 1, wherein the determining includes analyzing, by the at least one processor, the received description of the second task to determine whether the second task is duplicative of the first task,
wherein when the second task is determined as being duplicative, the method further comprises transmitting, to the user, a message that includes a notification of the duplicativeness determination and a recommendation for adjusting the description of the second task in order to avoid a subsequent redundancy.

7. The method of claim 1, further comprising analyzing, by the at least one processor, a result of the tracking of the execution of the first task to detect a problem caused by the execution of the first task; and
transmitting, to the user, a message that includes a notification of the detected problem and a recommendation for adjusting the description of the first task in order to overcome the detected problem.

8. The method of claim 1, further comprising:
determining, based on a result of the tracking, whether the execution of the first task is expected to cause a delay in a completion of the first project; and
transmitting, to the user, a status message that includes information that relates to a result of the determining of whether the execution of the first task is expected to cause the delay in the completion of the first project.

9. The method of claim 8, wherein when a determination is made that the execution of the first task is expected to cause the delay in the completion of the first project, the method further includes identifying at least one additional resource to be applied to the first project in order to overcome the expected delay.

10. A computing apparatus for managing a task, the computing apparatus comprising:
a processor;
a memory; and
a communication interface coupled to each of the processor and the memory,
wherein the processor is configured to:
receive, from a user via the communication apparatus, and store in the memory, a description of a first task and a description of a second task that relate to a first project that has not been completed;
perform analysis of the first task and the second task using a machine learning algorithm;
determine whether the first task and the second task have utility for the first project or not;
prevent further processing of the second task, when the machine learning algorithm determines that the second task does not have utility for the first project; and
when the first task is determined to have utility, the processor is configured to perform:
generate a plan for executing the first task based on the received description of the first task and historical task management information that relates to at least one task that has been completed;
initiate an execution of the first task based on the generated plan; and
track the execution of the first task in order to determine whether the execution is progressing in accordance with the generated plan.

11. The computing apparatus of claim 10, wherein the historical task management information includes, for each of the at least one task that has been completed, information that relates to at least one respective skill required for completing the respective task and information that relates to a respective amount of time required for completing the respective task, and
wherein the processor is further configured to generate the plan by using the machine learning algorithm that is trained by using the historical task management information and that generates an output that includes first information that relates to identifying at least one skill required for performing the first task and second information that relates to an amount of time expected to be required for completing the execution of the first task.

12. The computing apparatus of claim 11, wherein the historical task management information further includes personal information that identifies a plurality of persons and indicates, for each person included in the plurality of persons, a respective list of skills, and
wherein the output generated by the machine learning algorithm further includes third information that relates to identifying at least one person from among the plurality of persons to be assigned to perform the first task.

13. The computing apparatus of claim 12, wherein the historical task management information further includes, for each of the at least one task that has been completed, information that relates to a priority level for the respective task, and
wherein the output generated by the machine learning algorithm further includes fourth information that relates to assigning a priority level to the first task.

14. The computing apparatus of claim 13, wherein the historical task management information further includes, for each of the at least one task that has been completed, information that relates to a complexity of the respective task, and
wherein the output generated by the machine learning algorithm further includes fifth information that relates to determining a complexity of the first task.

15. The computing apparatus of claim 10, wherein the processor is further configured to:
analyze the received description of the second task to determine whether the second task is duplicative of the first task, and
transmit, to the user via the communication interface when the second task is determined as being duplicative, a message that includes a notification of the duplicativeness determination and a recommendation for adjusting the description of the second task in order to avoid a subsequent redundancy.

16. The computing apparatus of claim 10, wherein the processor is further configured to:
analyze a result of the tracking of the execution of the first task to detect a problem caused by the execution of the first task; and
transmit, to the user via the communication interface, a message that includes a notification of the detected problem and a recommendation for adjusting the description of the first task in order to overcome the detected problem.

17. The computing apparatus of claim 10, wherein the processor is further configured to:
determine, based on a result of the tracking, whether the execution of the first task is expected to cause a delay in a completion of the first project, and
transmit, to the user via the communication interface, a status message that includes information that relates to a result of the determination of whether the execution of the first task is expected to cause the delay in the completion of the first project.

18. The computing apparatus of claim 17, wherein when a determination is made that the execution of the first task is expected to cause the delay in the completion of the first project, the processor is further configured to identify at least one additional resource to be applied to the first project in order to overcome the expected delay.

19. A non-transitory computer readable storage medium storing instructions for managing a task, the storage medium comprising executable code which, when executed by a processor, causes the processor to:
receive, from a user, and store in a memory, a description of a first task and a description of a second task that relate to a first project that has not been completed;
perform analysis of the first task and the second task using a machine learning algorithm;
determine whether the first task and the second task have utility for the first project or not;
prevent further processing of the second task, when the machine learning algorithm determines that the second task does not have utility for the first project; and
when the first task is determined to have utility, further causes the processor to:
generate a plan for executing the first task based on the received description of the first task and historical task management information that relates to at least one task that has been completed;
initiate an execution of the first task based on the generated plan; and
track the execution of the first task in order to determine whether the execution is progressing in accordance with the generated plan.

20. The storage medium of claim 19, wherein the historical task management information includes, for each of the at least one task that has been completed, information that relates to at least one respective skill required for completing the respective task and information that relates to a respective amount of time required for completing the respective task, and
wherein the executable code is further configured to cause the processor to generate the plan by using the machine learning algorithm that is trained by using the historical task management information and that generates an output that includes first information that relates to identifying at least one skill required for performing the first task and second information that relates to an amount of time expected to be required for completing the execution of the first task.
